(19) United States
(12) Patent Application Publication
(10) Pub. No.: US 2009/0144387 A1
(43) Pub. Date: Jun. 4, 2009

(54) Methods and Systems for Targeted Messaging and Group Based Media Management

(75) Inventors: Howard Smith, Morgan Hill, CA (US); Anthony Bettencourt, San Francisco, CA (US)

Correspondence Address: Venture Pacific Law, PC, 5201 Great America Parkway, Suite 270, Santa Clara, CA, 95054, US

(73) Assignee: REACT SYSTEMS, INC., Los Altos, CA (US)

(21) Appl. No.: 12/326,097

(22) Filed: Dec. 1, 2008

Related U.S. Application Data
(60) Provisional application No. 60/991,358, filed on Nov. 30, 2007.

(51) Int. Cl. G06F 15/16

(52) U.S. Cl. 709/207

(57) ABSTRACT

A method for sending a single alert to a plurality of recipients based on the properties of each of the recipients and of the respective receiving devices of the recipients, where each of the recipients is assigned to a media class and one or more recipient groups, comprising the steps of: creating an alert, wherein the alert having a plurality of messages; assigning each of the messages to one or more media classes; first determining one or more recipients as a function of the assigned media classes and the recipient groups; second determining the messages for the recipients as a function of the assigned media classes; and sending the messages.

### CROSS REFERENCE

This application claims priority from a provisional patent application entitled “Targeted Messaging and Group Based Media Management” filed on Nov. 30, 2007 and having an Application No. 60/991,358. Said application is incorporated herein by reference.

### FIELD OF INVENTION

This invention relates to methods and systems for distributing alert messages, and, in particular to, methods and systems for distributing targeted alert messages and group-based content via various channels.

### BACKGROUND

Often, urgent information is of a critical nature, such that it would be beneficial to have some reliable means to make reasonably sure that the information reaches a targeted audience. As well, urgent information, by its nature, sometimes is time-sensitive, such that it is desirable the information be disseminated to the targeted audience as expeditiously as possible.

Existing alert distribution systems generally rely on a blanket method of distribution, using broadcast media (e.g., television and radio stations) to inform the public of urgent information. Such distribution systems are overbroad, in that each person watching television or listening to the radio in a given broadcast area is subjected to repeat broadcast of the information whether or not it even applies to or is of interest to that person. The systems are also under-inclusive in that certain people to whom the alerts may be of vital interest will not receive the alert if they are not either watching television or listening to the radio.

Therefore, it is desirable to provide methods and systems for more timely and selective distribution of urgent information for those to whom the information likely would be of interest.

### SUMMARY OF INVENTION

An object of this invention is to provide methods and systems for expeditiously distributing thousands of alert messages to a plurality of various devices.

Another object of this invention is to provide methods and systems for customizing the content of an alert message based on the properties of the recipients.

Yet another object of this invention is to provide methods and systems for distributing alert messages to various types of devices (e.g. cell phones, home phones, facsimile (fax) machines, personal digital assistants, computers, LCD televisions, and other devices).

And yet another object of this invention is to provide methods and systems for distributing alert messages via various channels (e.g. emails, voice messages, SMS messages, instant messaging (IM), facsimile, video messages, Flash messages, images, multimedia messages, television, radio, and other present and future channels).

And yet another object of this invention is to provide methods and systems for disturbing multiple alert messages with different content based on a single action by an initiator of the message (e.g. by a user who launches the alert).

Furthermore, yet another object of this invention is to manage the distribution of media based on the size of the media to be distributed and based on the characteristics of the recipient of the media.

Briefly, a method for sending a single alert to a plurality of recipients based on the properties of each of the recipients and of the respective receiving devices of the recipients, where each of the recipients is assigned to a media class and one or more recipient groups, comprising the steps of: creating an alert, wherein the alert having a plurality of messages; assigning each of the messages to one or more media classes; first determining one or more recipients as a function of the assigned media classes and the recipient groups; second determining the messages for the recipients as a function of the assigned media classes; and sending the messages.

An advantage of this invention is that thousands of alert messages can be expeditiously distributed to a plurality of various devices.

Another advantage of this invention is that the content of an alert message can be customized based on the properties of the recipients.

Yet another advantage of this invention is that alert messages can be distributed to various types of devices (e.g. cell phones, home phones, fax machines, personal digital assistants, computers, LCD televisions, and other devices).

And yet another advantage of this invention is that alert messages can be distributed via various channels (e.g. emails, voice messages, SMS messages, IM, fax, video messages, Flash messages, images, multimedia messages, television, radio, and other present and future channels).

And yet another advantage of this invention is that alert messages with different content can be distributed based on a single action by an initiator of the message.

Furthermore, yet another advantage of this invention is that the distribution of media can be directed to various locations based on the size of the media to be distributed and based on the characteristics of the recipient of the media.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a mathematical representation for selecting an alert message based on the properties of a recipient.

FIG. 2 illustrates a process flow for a presently preferred embodiment of this invention for distributing alert messages.

FIG. 3 illustrates a process flow for determining valid recipients to whom alert messages are sent.

FIG. 4 illustrates a block diagram for retrieving media class information for valid recipients, and adding that information to the data of a respective valid recipient.

FIG. 5 illustrates a process flow for selecting content for a particular alert message.

FIG. 6 illustrates a process flow for retrieving a list of contact information for recipients of an alert message.

FIG. 7 illustrates a system for one of the embodiments of this invention for distributing messages to targeted recipients.

FIG. 8 illustrates various relationships between tables in an activity database.

FIG. 9 illustrates an access control subsystem.

### DETAILED DESCRIPTION OF THE PREFERRED EMBODIMENTS

An alert message is distributed to one or more recipients via one or more channels, where the channels can include emails, voice messages, SMS messages, IM, fax, video messages, Flash messages, images, multimedia messages, television, radio, and other present and future channels). A recipient may be a user and/or a player. A user is a person that can receive an alert message, or can otherwise manage an alert message. A player may be a device that can display a message (e.g. a computer, a pda, or other display terminal). A recipient's properties can include the position of the recipient within an organization, the recipient's home location, the recipient's current location, a user group to which the recipient is a member, a property group to which a recipient is a member, and other properties of the recipient.

In one embodiment of the present invention, each recipient must be a member of one and only one property group. However, each recipient can be members of several user groups. Furthermore, each recipient can have a contact list that includes one or more contact addresses associated with the respective recipient (e.g. an cellular number, a telephone number, a fax number, an email, a home address, a work address, and so forth), and a current location for the recipient. This current location for a recipient may be found by various methods. For instance, if a recipient has a GPS device, the GPS device can be used to transmit the location of the recipient. If a recipient is a non-mobile player, then the location of the player can be set to the geographical location to which the player resides.

An alert is launched based on the following requirements: (1) all recipients for the alert must be members of a user group that the alert targets; and (2) all recipients receiving the alert must be members of a property group that has associated information for the alert.

For instance, an engineer A (with a cellular phone number as his or her contact address) located in building 12 can be assigned to a user group, the Engineers Group, and a property group, the Building 12 Property Group. Thus, the engineer A's home location can be identified as Building 12, and an associated script for the engineer A is “All engineers in Building 12 should report to campus 12. This is an urgent alert.”

An engineer B (with an email address as his or her contact address) located in building 14 would be similarly assigned to the Engineers Group, but to a different property group, the Building 14 Property Group. Thus, the engineer B's home location can be identified as Building 14, and an associated script for engineer B is “All engineers in Building 14 should report to campus 14. This is an urgent alert.”

If an alert is launched by a Security Group, the engineer A would receive the following message on his cell phone: “All engineers in Building 12 should report to campus 12. This is an urgent alert”. The engineer B would receive the following email “All engineers in Building 14 should report to campus 14. This is an urgent alert.”

In a presently preferred embodiment of the present invention, a property group can be referred to as a media class. A media class can have the following properties: (1) a script property for providing a text for an alert message; and (2) an image property for providing a graphical image for the alert message. A media class may have multiple script and image pairs to support multiple alerts.

In the presently preferred embodiment, each recipient must be a member of one and only one media class. However, each recipient can be members of several user groups. Furthermore, each recipient can have a contact list that includes one or more contact addresses associated with a recipient via various channels, and a current location for the recipient. The current location for a recipient can be found via the recipient's GPS device or other means of location. Additionally, every media class must have a valid script for an alert that refers to the media class.

When an alert is launched, the following rules can be used to distribute the alert to its targeted recipients. First, a recipient must be a member of a group that the alert targets. Second, the recipient must be a member of a media class possessing a valid script for that alert. In summary, a recipient must be a member of both the group the alert has targeted and a media class able to display the associated message for that alert.

For instance, an administrator can create two media classes, one referred to as the “Desktop” media class and the other referred to as the “Public Screen” media class. All desktop players are added to the Desktop media class, and all dedicated displays and public displays are added to the Public Screen media class. The administrator creates a script referred to as “Code Gray” in the “Desktop” media class with the message, “Please be on the lookout for an armed individual.” The administrator can then create an additional script which must be named the same, “Code Gray,” in the Public Screen media class with the message, “Please report suspicious individuals to security.” When a Code Gray alert is launched to all players, it will appear on the desktop players with the message for the “Desktop” media class, “Please be on the lookout for an armed individual,” while the public displays will show the other message, “Please report suspicious individuals to security.” In this way, customized alert messages (one for the Desktop media class and one for the Public Screen media class) can be sent with one alert, the Code Gray alert.

Extending this example further, assume the desktop players are in a user group, referred to as the “Building Oakland Security” user group, and the public players are in a user group, referred to as the “Building Oakland Public Rooms” user group. When an alert is targeted at only the Building Oakland Security user group, only the desktop players display the alert, and not the public players, because the public players are not members of the Building Oakland Security user group. Players located in other buildings, for instance a Building Fremont Security user group, that may also be members in the “Desktop” media class will not display the alert since a recipient must be a member in the targeted group for the alert, and a member of a media class capable of displaying the alert (i.e. a media class that has a valid script for that alert).

The present invention can also be applied to the movement of media based on media classes. More specifically, if a player is not capable of displaying an alert, the player is not sent the alert's associated media.

For instance, assume a hospital has 1000 desktop players, where these players are members in a Desktop media class. The users of these players may be the hospital security staff and nursing staff. A Public Screen media class can have a membership comprising 20 wide screen public displays, wherein those displays playback 10 different high resolution MPEG advertisements for various products sold in the hospital's pharmacy. Each advertisement may require 100 MB of storage to store the advertisement. Therefore, the total size for the advertisements can reach 1 GB.

For the players in the Public Screen media class, it may take around 20 hours to download all the advertisements. For the players in the Desktop media class it would take nearly 50 times that amount of time (i.e. around 41 days), given the same bandwidth since there are 50 times more desktops than wide screen public display screens.

The alerting system may chose to not download those advertisements to any user group that would take longer than 20 hours to download. Therefore, when the public screen alert is invoked, it will only download to the members in the public screen media class.

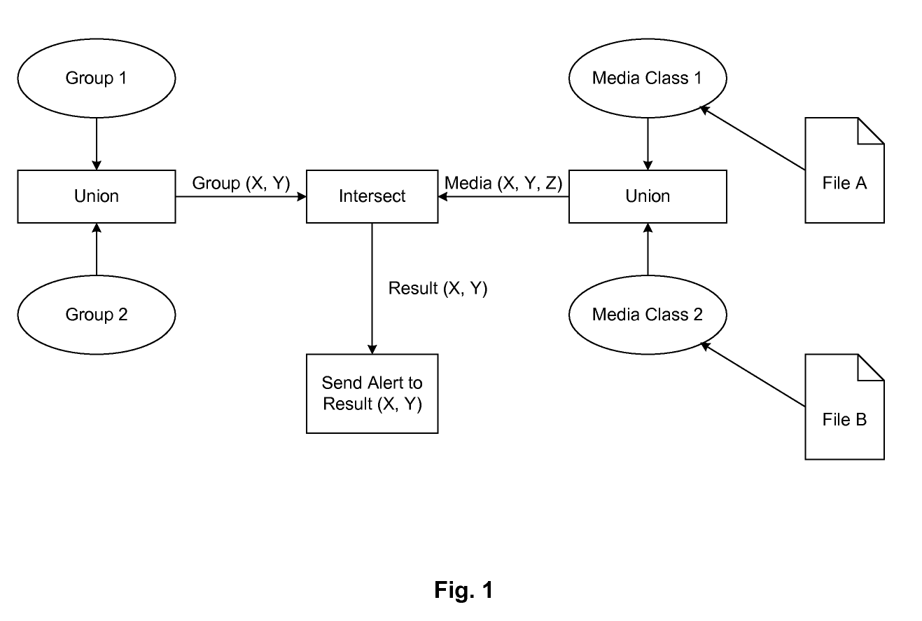

FIG. 1 illustrates a mathematical representation for selecting an alert message based on the properties of a recipient. In the first step, a group 1, a group 2, a media class 1, and a media class 2 are created. In the second step, members, herein referred to as X members, are added to the group 1 and added to the media class 1. Other members, herein referred to as Y members, are added to the group 2 and added to the media class 2. Yet other members, herein referred to as Z members, are added to the media class 1. In a third step, a file A is associated with the media class 1, and a file B is associated with the media class 2.

Thus, the group 1 members are the X members; the group 2 members are the Y members; the media class 1 members are the X members, who are associated with the file A; and the media class 2 members are the Y members, who are associated with the file B. A new group, referred to as group (X, Y), can be created by applying a union operator on the group 1 and the group 2. A new media class, herein referred to as media (X, Y, Z), can be created by applying a union operator on the media class 1 and the media class 2, where the media class has: (1) the file A associated with the X members and the Z members; and (2) the file B associated with the Y members. Next, the intersection between the group (X, Y) and the media (X, Y, Z) is found; the result of which is referred to as result (X, Y) with file A associated with the X members and the Y members.

If an alert message is to be sent to the group 1, the group 2, the media class 1, and the media class 2, then the alert message can be generated using file A, and then sent to the X members and the Y members. The Z members are not sent the file since they are not members of either the group 1 or the group 2.

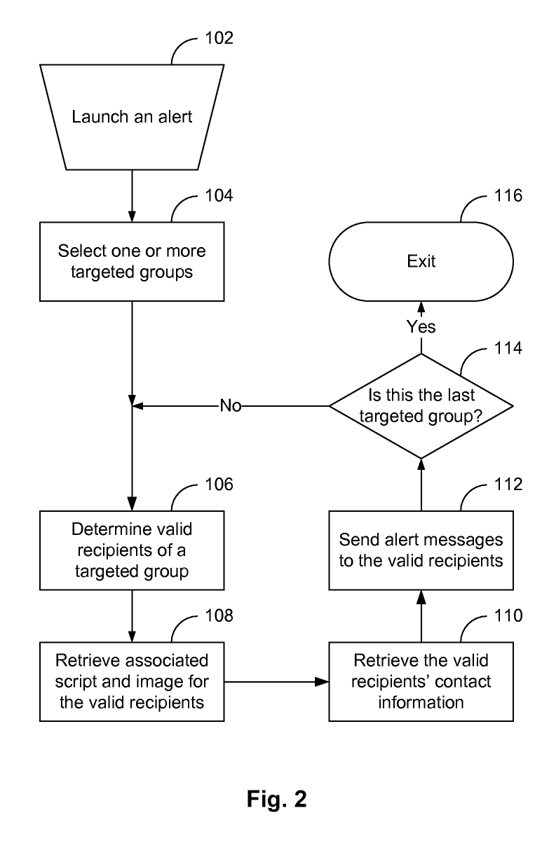

FIG. 2 illustrates a process flow for a presently preferred embodiment of this invention for distributing alert messages. An alert can be launched by a user 102. The user can select one or more user groups as targeted groups 104. For each targeted group, it is determined which members of the group, if any, are valid recipients 106. The associated script and/or associated image for each valid recipient of a targeted group are retrieved based on the media class to which that recipient belongs. The retrieved script and/or retrieved image can then be used to generate an alert message for the valid recipients 108. In other embodiments of this invention, the associated data can be multimedia, voice data, combination of various data, or other data.

To receive an alert, a valid recipient must have a valid script for the alert. If not, then the alert is either not sent to the valid recipient, or the valid recipient is sent a blank message. Receiving a blank message can be the equivalent of not receiving an alert message since nothing is played to a recipient of that message or displayed to the recipient of that message. In this manner, recipients who are not members in both the targeted groups and media classes associated with the alert do not receive an alert with a message.

Contact addresses for each valid recipient are retrieved from the recipient's contact information 110. The message is then sent to the valid recipients 112. Next, if there are no more targeted groups to send an alert to 114, then exit 116. If there are more targeted groups, then the next targeted group is selected to determine whether that targeted group contains valid recipients.

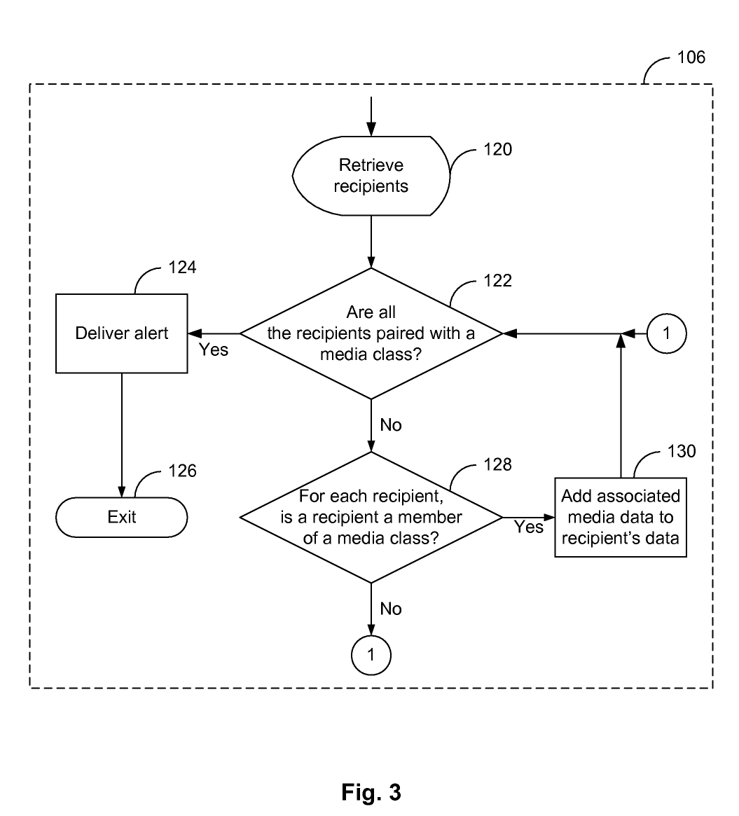

FIG. 3 illustrates a process flow for determining valid recipients to whom an alert message is sent. Alerts in the present embodiment of the invention are launched to one or more targeted groups. Each targeted group may comprise of user members and of player members. Each member of a targeted group must also be paired with a media class. A media class contains a script and an image. Additionally, the media class may contain other information, such as text, graphical images, voice messages, multimedia, and other data, for generating an alert message for a member of the media class. The script and the image can be used to generate the alert messages sent to a user member or a player member of that media class.

Recipients of a targeted group are retrieved 120. Next, the recipients are checked whether each recipient is paired with a media class 122. If so, then the recipients are valid, and can be delivered an alert 124. The validation process can then exit 126. If not, then each recipient is checked as to whether that recipient is a member of a media class 128. If so, then the associated script and/or image from the media class for that recipient are added to the recipient's data 130. The rest of the recipients are checked to see whether they are paired with a media class 122. If a recipient is not a member of a media class, then that recipient is skipped. The rest of the recipients are checked whether they are paired with a media class 122.

Note that all members of a targeted user group must be a member of a media class associated with a launched alert to receive alert messages. The media class contains the information used to generate alert messages for members of this class. This information may include simple text, graphical images, multimedia information, or other information.

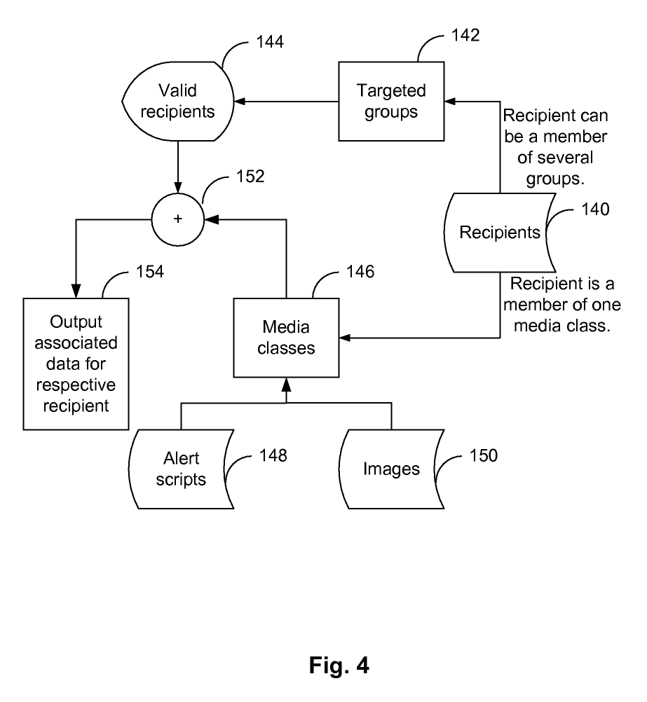

FIG. 4 illustrates a block diagram for retrieving media class information for valid recipients, and adding that information to the data of a respective valid recipient. Each of the recipients 140 is determined as to whether or not that recipient is a member of one of the targeted groups 142. If so, then this recipient may be a valid recipient 144, and the information (i.e. alert scripts 148 and images 150) from the respective media class 146 for that recipient are combined with the data of the valid recipient 152. Last, the combined data for each recipient is outputted 154.

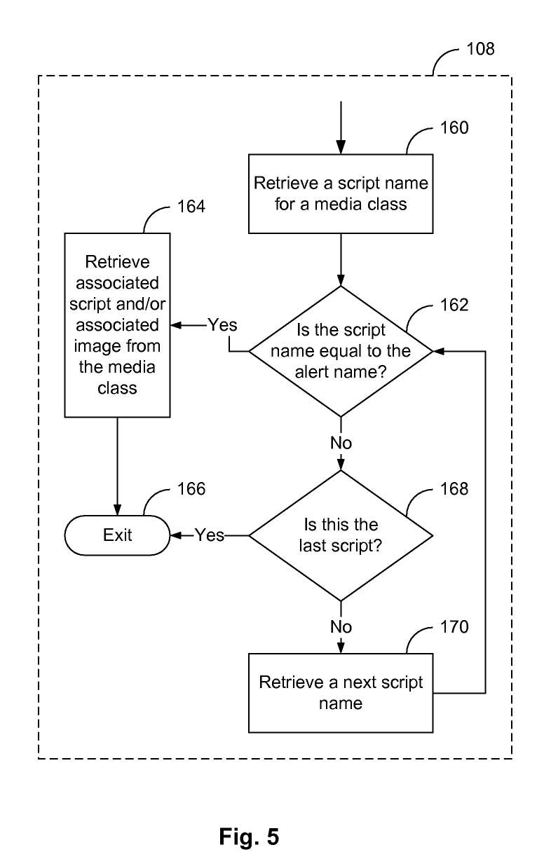

FIG. 5 illustrates a process flow for selecting content for a particular alert message. A media class will have a script and an image pair for each alert that references the media class. The media class can be associated with multiple alerts; therefore the media class can have multiple pairs. First, a script name is retrieved for a media class 160. Next, the script name is compared with the alert name 162. If the names are the same, then an associated script and an associated image for that script name are retrieved from the media class 164. The process can then exit from this loop 166. However, if the script name does not match, then it is determined whether this script name is the last script name of the media class to be checked 168. If so, then there are no more script names to be checked, and this process can exit 166. If not, then the next script name is retrieved from the media class 170 to be compared with the alert name 162.

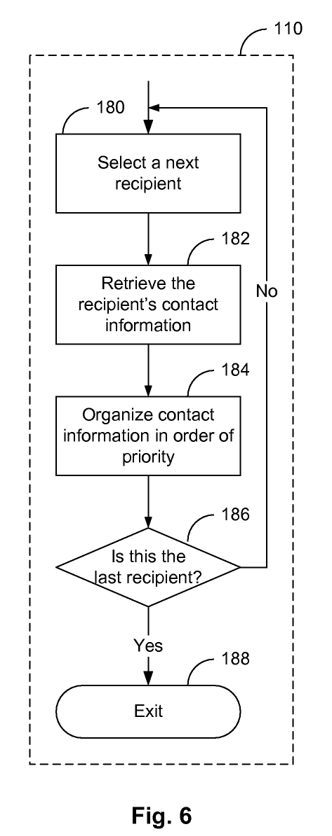

FIG. 6 illustrates a process flow for retrieving a list of contact information for recipients of an alert message. Each recipient has contact information containing contract addresses for that recipient. Those contact addresses may be a simple IP address of a player on a PC or other addresses for users (e.g. cell phone number, home phone number, SMS cell numbers, email addresses, office location, etc). First, a recipient is selected from a group of recipients 180 to process. The recipients contact information is then retrieved 182.

Each contact address within a contact list can be ordered within the list in terms of a priority. Priority is bases on which contact address to use first for sending an alert message 184. For instance, when an alert message is launched to a recipient, the contact list for that recipient can be prioritized such that the recipient's cell phone number is called first, then a SMS text message is sent to the recipients' cell phone number, and finally the recipient's office number is called.

It is next determined whether the recipient is the last recipient 186. If so, then exit 188 because there are no recipients that need their contact information retrieved. If not, then select a next recipient to retrieve his or her contact information 180.

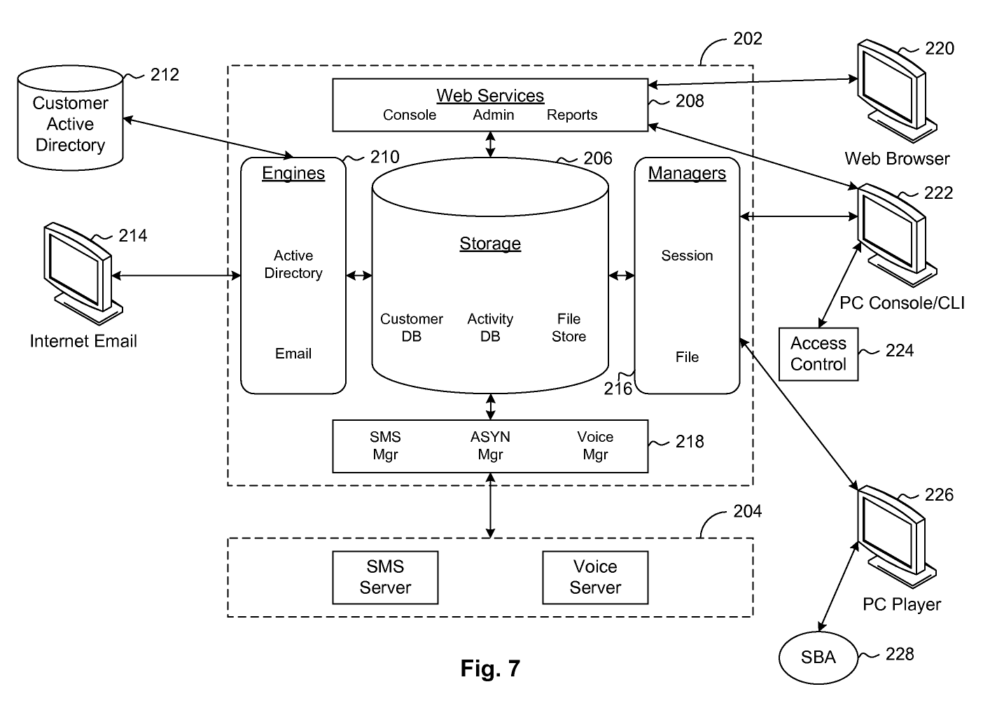

FIG. 7 illustrates a system for one of the embodiments of this invention for distributing messages to a group of targeted users. This system comprises a server 202, third party service providers 204, and a plurality of customers connected to the server 202 via one or more channels. The customer side devices can be either local to the server 202 or remote from the server 202. Customers can comprise of administrators, recipients, initiators, users, and players.

The server 202 comprises various software/hardware components that are grouped together by type to aid in the understanding of the present embodiment of the present invention. These components may be integrated to the server 202, or externally connected to the server 202. In the storage grouping 206 is a customer database, an activity database, and a file storage unit. Database may be herein referred to as DB. The customer DB stores customer information. The activity DB provides the capability to authenticate customers, synchronize with customers, and store various tables used to generate alert messages. The file store unit stores all the messages, where those messages are mapped to the server's 202 native file system.

The web services grouping 208 comprises a console web service, an admin web service, and a reports web service. The console web service generates an interface for an administrator. The reports web service is a web server report engine that generates reports for web clients and non-web clients. Clients can comprise of administrators, recipients, initiators, users, and players.

The engines grouping 210 comprises an active directory engine and an email engine. The active directory engine provides authentication and synchronization with customers to an active directory 212. The email engine composes emails used for delivering alert messages via and used for delivering status reports of previously sent alerts. The email engine can deliver emails to a computer 214 via a network.

The managers grouping 216 comprises a session manager and a file manager. The session manager manages and authenticates network sessions from non-web based clients. The file manager enables clients to store generic files on the server 202.

Another group of managers, referred to as channel managers 218, comprise a SMS manager, an ASYN manager, and a voice manager. These managers connect with third party providers 204 to send alert messages using a third party's resources (e.g. a third party's SMS server or a third party's voice server). More specifically, the SMS manager distributes SMS messages and SMS reports to an SMS address via a third party's server. The ASYN manager manages two-way communications between a client and an administrator of the server 202 via a voice connection or a SMS connection. The voice manager generates and delivers voice phone messages and delivers voice reports.

On the client side, the client can access the server 202 via a web browser connection 220. Additionally, a personal computer (PC) console with a command line interface (CLI) 222 can be used to access and manage the server 202. The console can be simply a user interface on the client's computer. The CLI is used for automating various administrative functions of the system. An access control 224 can map third party system events to alerts generated in this system. A PC player 226 can be used on the client side to simply display one or more alerts. The PC player 226 can also have a single button alert (SBA) 228, which replicates an alert button in the console user interface on the PC player 226.

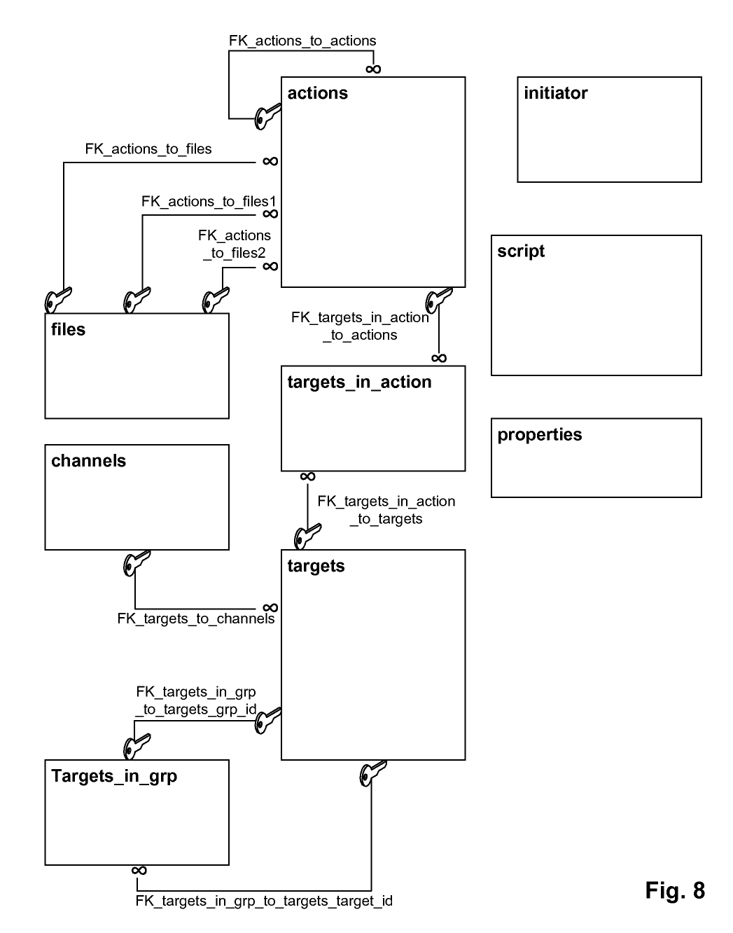

FIG. 8 illustrates various relationships between tables in an activity database. An activity database can store multiple tables used for sending out alerts. These tables can comprise of an actions table, an initiator table, a script table, a targets in action (TIA) table, a files table, a channels table, a targets table, a properties table, a targets_in_grp table, and other tables. These tables are linked together with foreign keys. For instance, there is a many to one relationship between the actions table and the files table. There is a one to one relation between the target table and the targets_in_grp table. The tables in the activity DB will be further explained in conjunction with the following examples.

Referring to the components in FIG. 7 and the tables in FIG. 8, the following examples can be used to illustrate the interplay between the tables and the components of the system.

Active Directory

With respect to the active directory, a user selects an Active Directory User as a target for alerts, where those alerts can be sent via SMS messaging, voice messaging, to a player of the active directory user, and by other methods. This can be implemented by sending a request for an active directory list from the customer database to an active directory engine. The active directory engine receives the list from the customer's active directory. If the user is not previously in a targets table of the customer database, then the user is added. If the user is already in the targets table of the customer database, then the user record is modified. The user is deleted from the targets table, if the user is not in the received list.

Add a Group

With respect to adding a group, a user selects a console group tool. The user then selects a new group, and enters a new group name. Members can then be added to the group. Finally, the group name and members can be confirmed by the user. This can be implemented by the console calling the session manager to add the new groups to the target table of the customer database. The members in this group can be added to the targets-in-group table.

Add a New User

With respect to adding a new user, the administrator can select a console user tool. Then select an add button, and finally enter the user's login information (e.g. user name and password) and the user's contact information (e.g. phone number, email address, and so forth). The administrator can then confirm the information, and store the user's information on the server 202. This can be implemented by the console calling the session manager to add the new group to the targets table of the customer database.

Add Users Information, e.g. SMS Number(s) and Phone Number(s)

With respect to adding contact addresses to a user's information, the user can select a console tool. The user then selects a user, and next selects an add phone number, SMS number, or other contact button. A SMS number or a phone number is entered, and then can be confirmed by the user. In terms of implementation, the console calls the session manager to add the information to the targets table of the customer database. The relationship is added between the new information and the user in the targets table of the customer database.

Adding SBA to a Client Computer

With respect to adding a SBA to a client computer or player, a SBA administrator runs on the client computer. A user can then select an alert button name. Next for that alert, the user can select one or more groups to receive such alert associated with that SBA, wherein those groups are identified by names. The SBA appears on the client's computer desktop. An implementation for this can be the SBA creator calls the session manager via the client's computer to verify the selected groups and button exists, and then creates a SBA button on the client's computer.

Cancel Alert

With respect to canceling alerts, the user can select an alert launcher from a console. An alert is managed by selecting a management option. In an alert manager, an alert can be canceled by selecting the alert from a list of active alerts. The deleted alert is then removed on all players that are currently displaying the alert or are currently tabbed on the player side.

An implementation for this can be that the console calls the session manager, then inserts actions into the action table, and inserts targets into the TIA table for processing. If a canceled alert is playing on a player type, then the session manager deletes the player from the TIA table. The session manager then sends a cancel action to all players. The session manager updates the status in the TIA table. On a player side, when the player receives a cancellation command from the session manager for a canceled alert, the player removes the display of that canceled alert.

Create Alert Button

With respect to creating an alert button, a user can add a button to the console, and then publish that button to be displayed on other consoles. An implementation of this can be that the console calls the session manager to add the new button to the initiator table of the customer database.

Create Alert Scripts

With respect to creating alert scripts, a user can upload images into the media manager. The user can then create a script by using a script tool. From this script tool, the user can create a SMS message, a speech message by inputting the text for the message, a text for an email, or other messages. The user can also add various backgrounds and slides in the display of the message on a display terminal or a player. The user can do this by selecting an image to be placed in the background of the displayed message. The script can then be saved.

An implementation for this can be to upload images to the console. The console can then call the file manager to store the selected media class in the file store, and then notifies the listeners. With respect to creating a script, the console calls the script manager to generate an XML script. The console then calls the file manager to store the XML script in the file store, and then notifies the listeners. The console also calls the session manager to update the script table via the SMS manager, voice manager, and email engine.

Create an Additional Media Class

With respect to creating an additional media class, the user can simply create an additional media class. Once the media class is created, one or more users and one or more players can be added. This can be implemented by the console calling the session manager to insert the new media class in the channel table of the customer database.

Delete Group

With respect to deleting a group, a group tool can be selected from the console. A delete button can be selected to delete the associated group. An implementation for this can be the console calls the session manager to flag the group as deleted in the targets table of the customer database.

Delete Media Class

With respect to deleting a media class, a user can select a media class for deletion. The user can then confirm that deletion. The console calls the file manager to delete all media corresponding to a media class. The console calls the session manager to delete the media class from the channel table of the customer database.

Delete SBA (Single Button Alert) Button

With respect to deleting a SBA button from a desktop, a user simply deletes the button file from his or her desktop.

Delete User Information

With respect to deleting user information, a user can select the console tool, and then select a user to delete. The user then selects the delete option to delete the user. An implementation for this can be the console calls the session manager to flag the information as deleted in the targets table of the customer database. The information is flagged instead of deleted so that reports can be generated based on the deleted user's information, regardless if the deleted user is no longer a current user.

Generate Reports

With respect to generating reports, the user can select a console tool. From there, the user selects a report button, and selects the type of report. The report is then generated based on the selected criteria, and displayed to the user. To implement this, the console calls the report engine with the selected criteria for the report, and then the report engines generate the report.

Install a Player

With respect to installing a player, the player needs to be registered with the server 202. The player can do this by calling the session manager to insert the player in the targets table of the customer database and insert the player to the default media class.

Launch Alert

With respect to launching an alert, a user can simply press the SBA, in which the console relays the alert to the server 202. This can be implemented by the console calling the session manager to insert the alert in the actions table, and to insert targets in the TIA table for processing.

If a target is a player type, the session manager reads a player target from the TIA table. The session manager sends the alert to all players, and updates the status in the TIA table.

If a target is a SMS type, the SMS manager reads the SMS target from the TIA table, and then sends the request to the service provider. The status in the TIA table is then updated.

If a target is a voice type, the voice manager reads the voice target from TIA table. The request is then sent to the service provider, and the status is updated in the TIA table.

If a target is an email type, then the email engine reads the email target from the TIA table, and composes the email from the email server. The status is then updated in the TIA table. Users can then receive the emails, SMS messages, and voice messages; and players can then display the alert.

Launch Alerts from the Command Line Interface (CLI)

To launch an alert from the CLI, the console/CLI calls the session manager to insert the alert in the action table of the customer database, and inserts targets into the TIA table for processing.

Launch SBA (Single Button Alert)

The user can launch the SBA by double clicking the SBA button for an associated alert on his or her desktop console. The SBA then calls the console/CLI. The console/CLI calls the session manager to insert the alert into the action table of the customer database. The targets are also inserted in the TIA table for processing.

Modify a Group

With respect to modifying a group, a user can select the console group tool, and then select a group from that tool to modify. The user can modify the member list of that group, and confirm any changes to the list. This can be implemented by the console calling the session manager to add/remove members from the targets-in-group table.

Modify SBA (Single Button Alert) Button

With respect to modifying a SBA button, a user can use a SBA admin running on a client computer to select existing SBAs. From this list a SBA button name can be selected. Groups, represented by their names, can then be added or deleted from being associated to the SBA button. The modify button can then be used to confirm any changes made. An implementation for this can be the console calls the session manager to verify a button name.

Modify User's Information

With respect to modifying a user's information, a user can select the console tool, then select a user to modify by pressing a modify button. The user can then enter information for that user or modify existing information. Then, the user can confirm any modification for the user. An implementation for this can be a console calls the session manager to flag the information as deleted in the targets table of the customer database, and then adds the modified information to the targets table of the customer database. Lastly, the relationship between the new information and the user is added in the targets table of the customer database.

Player Two-Way Communications

With respect to player two-way communications, a player displays alerts with a drop down list. The user can select a response from this list. This can be implemented by a player receiving an alert with a response list. Player displays this alert with a response list. The user can select a response from the list. The player then calls the session manger to update the corresponding TIA record of the customer database.

Player Waits for Events

With respect for a player waiting for events, when the player is downloaded, the player calls the session manager to register for events. When a file or other media is posted, the player notifies the session manager, and the session manager requests the file from the file store for the player.

Remove an Image or Wave File

With respect to removing an image file or a wave file, the user selects a media class to remove an image file or a wave file. For the selected media class, the user can then delete an image file or a wave file from the media class. This can be implemented by the console calling the file manager to delete the image file or the wave file from the file store.

Rename Media Class

With respect to renaming a media class, a media class can be selected, then renamed. This can be implemented by a console calling the session manager to update the media class name in the channel table of customer database.

SMS & Voice Two-Way Communications

With respect to SMS and voice two-way communications, when a user launches an alert, the user can generate a SMS response or voice response by choosing a number between 0-9 on the key pad of a receiving device (e.g. cellular phone) of the user. For players, the user selects a response from a drop down list as previously described.

An implementation for this can be a SMS message is sent to the service provider. Next, the SMS manager updates the activity database with the message number. The service provider then sends a response to the ASYN manager. The ASYN manager locates the message number in the activity database and stores the response. The SMS manager gets the response from the activity database, and updates the TIA record in the customer database.

An implementation for this can be a voice message is sent to the service provider. The voice manager updates the activity database with the message number, and the service provider sends a response to the ASYN manager. The ASYM manager locates the message number in the activity database and stores the response. The voice manager gets the response from the activity database and updates the TIA record in the customer database.

Web Browser to Modify User Attribute

With respect to modifying user attributes via a web browser, a user logs in to the console by using a login name and password. The user can modify the contact information, and save the modified information. This can be implemented by the web browser calling the console to modify the user's contact information in the targets table of the customer database.

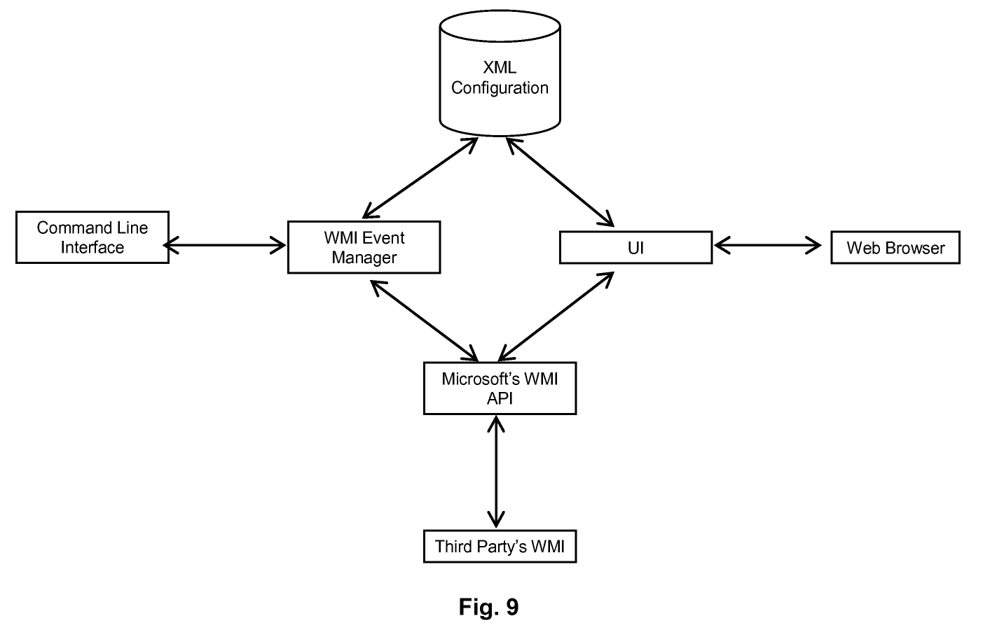

FIG. 9 illustrates an access control subsystem for a method of this invention. A user selects the events to monitor from the list of third party events. The user then maps the selected events to alerts.

The WMI event manager reads the XML configuration, and registers for notification of WMI events. The WMI event manager receives an event notification and passes the alert to the command line interface.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for sending a single alert to a plurality of recipients based on the properties of each of the recipients and of the respective receiving devices of the recipients, where each of the recipients is assigned to a media class and one or more recipient groups, comprising the steps of:
creating an alert, wherein the alert having a plurality of messages;
assigning each of the messages to one or more media classes;
first determining one or more recipients as a function of the assigned media classes and the recipient groups;
second determining the messages for the recipients as a function of the assigned media classes; and
sending the messages.

2. The method of claim 1 wherein the messages are customized based on the alert.

3 The method of claim 1 wherein the messages are customized based on the media class of the recipients.

4. The method of claim 1 wherein each recipient is assigned to a recipient group based on the location of the recipient in the first determining step.

5. The method of claim 1 wherein each of the media class defines one or more methods for sending a message and one or more channels related thereto, and the messages are sent via the channels.

6. The method of claim 5 wherein the channels include email, sms, voice, fax, instant messaging, and voicemail.

7. The method of claim 1 wherein each recipient is associated with one or more contact addresses and each of the contact addresses is associated with a device capable of playing one or more media types.

8. The method of claim 7 wherein each of the messages has one or more media types and the media types of the messages are customized depending on the media types of the devices.

9. The method of claim 8 wherein the messages are playback on the devices in the media types of the messages.

10. The method of claim 1 further including a step before the sending step for modifying a selected message.

11. The method of claim 10 wherein the selected message has content in a first media type and is modified to include content in a second media type.

12. The method of claim 1 wherein each of the alerts has a priority, and, in the event where there are an alert having a higher priority and an alert having a lower priority are to be sent, and the alerts have different priorities, the alert having the higher priority is displayed first.

13. The method of claim 12 wherein the alert having the lower priority is displayed after the alert having the higher priority ceases.

14. The method of claim 1 further including a step after the sending step for receiving one or more replies in response to the sent messages.

15. The method of claim 14 wherein each of the replies is automatically routed and processed according to the sent messages.

16. The method of claim 1 wherein the messages are updated and re-sent after the sending step.

17. The method of claim 1 wherein a log is saved with respect to the steps.

18. The method of claim 17 wherein the log can be re-played.

19. A method for sending a single alert to a plurality of recipients based on the properties of each of the recipients and of the respective receiving devices of the recipients, where each of the recipients is assigned to a media class and one or more recipient groups, comprising the steps of:
creating an alert, wherein the alert having a plurality of messages;
assigning each of the messages to one or more media classes;
first determining one or more recipients as a function of the assigned media classes and the recipient groups, wherein each recipient is associated with one or more contact addresses and each of the contact addresses is associated with a device capable of playing one or more media types, and wherein each of the messages has one or more media types and the media types of the messages are customized depending on the media types of the devices;
second determining the messages for the recipients as a function of the assigned media classes, wherein the messages are customized based on the alert and based on the media class of the recipients; and
sending the messages, wherein each of the media class defines one or more methods for sending a message and one or more channels related thereto, and the messages are sent via the channels.

20. A method for sending a single alert to a plurality of recipients based on the properties of each of the recipients and of the respective receiving devices of the recipients, where each of the recipients is assigned to a media class and one or more recipient groups, comprising the steps of:
creating an alert, wherein the alert having a plurality of messages, wherein each of the alerts has a priority, and, in the event where there are an alert having a higher priority and an alert having a lower priority are to be sent, and the alerts have different priorities, the alert having the higher priority is displayed first, and wherein the alert having the lower priority is displayed after the alert having the higher priority ceases;
assigning each of the messages to one or more media classes;
first determining one or more recipients as a function of the assigned media classes and the recipient groups, wherein each recipient is assigned to a recipient group based on the location of the recipient, wherein each recipient is associated with one or more contact addresses and each of the contact addresses is associated with a device capable of playing one or more media types, wherein each of the messages has one or more media types and the media types of the messages are customized depending on the media types of the devices, and wherein the messages are playback on the devices in the media types of the messages;
second determining the messages for the recipients as a function of the assigned media classes, wherein the messages are customized based on the alert and based on the media class of the recipients;
modifying a selected message, wherein the selected message has content in a first media type and is modified to include content in a second media type;
sending the messages, wherein each of the media class defines one or more methods for sending a message and one or more channels related thereto, and the messages are sent via the channels, and wherein the channels include email, sms, voice, fax, instant messaging, and voicemail; and
receiving one or more replies in response to the sent messages, wherein each of the replies is automatically routed and processed according to the sent messages;
wherein the messages are updated and re-sent after the sending step, wherein a log is saved with respect to the steps, and wherein the log can be re-played.
